(19) United States
(12) Patent Application Publication
(10) Pub. No.: US 2007/0201696 A1
(43) Pub. Date: Aug. 30, 2007

(54) PROFILE ACQUIRING METHOD, APPARATUS, PROGRAM, AND STORAGE MEDIUM

(75) Inventors: TAKASHI HIRATA, Yokohama-shi (JP); KENICHI FUJII, Yokohama-shi (JP); MASAKI SHITANO, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/741,829

(22) Filed: Apr. 30, 2007

Related U.S. Application Data
(63) Continuation of application No. PCT/JP05/19512, filed on Oct. 24, 2005.

(30) Foreign Application Priority Data
Nov. 9, 2004 (JP) 2004-325095

(51) Int. Cl. H04N 1/44

(52) U.S. Cl. 380/243

(57) ABSTRACT

Preliminary information is received from a communication partner, a method of acquiring a profile of the communication partner is determined in accordance with the preliminary information received from the communication partner, and the profile is acquired from the communication partner by the determined method.

### TECHNICAL FIELD

The present invention relates to a profile acquiring method, apparatus, program, and storage medium.

### Background Art

The advance of computer technologies is beginning to realize functions such as association and linking of processes across networks even in office apparatuses and general household appliances. Apparatus control protocols such as UPnP (Universal Plug and Play), Jini (registered trademark), and Jxta (registered trademark) are known as network technologies that implement fusion of these apparatus controllers across networks.

UPnP will be described below as a representative example. UPnP is an apparatus control protocol used on networks that support practical standard protocols, such as IP (Internet Protocol), TCP (Transfer Control Protocol), UDP (User Datagram Protocol), HTTP (HyperText Transfer Protocol), and XML (eXtensible Markup Language), in the Internet world.

UPnP uses SSDP (Simple Service Discover Protocol) to find an apparatus controller connected to a network, and grasp profile information expressing the predefined specifications and settings of an apparatus controller to be controlled. SSDP is a fundamental portion that constitutes UPnP, and IETF has issued standard specifications. UPnP uses IP broadcast to find an apparatus. For example, when “an apparatus capable of playing back digital video streams?” is broadcast, apparatuses matching the condition voluntarily transmit their IP addresses and host names to the inquiry source. Also, the profile information indicating the predefined specifications and settings and practical functions of an apparatus controller is exchanged at that time. The data format used in information exchange is XML, and the information is communicated by HTTP.

SOAP (Simple Object Access Protocol) is used to control an apparatus. SOAP is an RPC-based Internet communication industry standard protocol that is determined in order to smoothly exchange XML Web services. SOAP is used to transmit a control message to an apparatus, and obtain a result or error. A UPnP control request is a SOAP message containing an action that calls by designating a parameter. The response is also a SOAP message and contains a status, and a value and parameter are returned.

An apparatus control protocol (e.g., UPnP) used to interconnect apparatuses across a network often adopts a method that exchanges the entire profile information having a predetermined structure following one predetermined profile exchanging procedure (e.g., SSDP).

Patent reference 1, for example, describes that an information providing form can be selected in accordance with cost information.

Patent reference 1 describes an information providing method and information providing system that allow a user to select a content providing form in accordance with the communication band and the printing cost such as paper when accepting provided content information.
Patent reference 1: Japanese Patent Laid-Open No. 2000-298675

### DISCLOSURE OF INVENTION

### Problems that the Invention is to Solve

The apparatus control protocols represented by UPnP described above exchange the whole profile information. If the amount of profile information is large, therefore, it sometimes takes a long time to acquire the profile information depending on the network status such as the communication speed of a network to which an apparatus controller is connected, and the conditions such as the memory capacity and CPU speed unique to the apparatus controller.

The present invention has been made in consideration of the above problems, and has as its object to make it possible to select a profile acquiring method suited to a communication partner.

It is another object of the present invention to make it possible to acquire necessary information of profile information by tracing a hierarchy.

### Means of Solving the Problems

A profile acquiring method of the present invention determines a method of acquiring a profile of a communication partner in accordance with information received from the communication partner, and acquires the profile from the communication partner by the determined method.

In the determining step, the profile acquiring method of the present invention acquires desired information from hierarchized profile information of the communication partner by tracing the hierarchy.

In the acquiring step, the profile acquiring method of the present invention acquires element information of a predetermined layer from hierarchized profile information of a connection partner, selects an element to be acquired next from the acquired element information, and acquires element information of the selected element, in accordance with the determined method.

A profile acquiring apparatus of the present invention comprises a determination unit adapted to determine a method of acquiring a profile of a communication partner in accordance with information received from the communication partner, and an acquisition unit adapted to acquire the profile from the communication partner by the method determined by the determining means.

A profile acquiring program of the present invention determines a method of acquiring a profile of a communication partner in accordance with information received from the communication partner, and acquires the profile from the communication partner by the determined method.

A computer-readable storage medium of the present invention stores a profile acquiring program, which determines a method of acquiring a profile of a communication partner in accordance with information received from the communication partner, and acquires the profile from the communication partner by the determined method.

### Effects of the Invention

The present invention makes it possible to acquire a profile by a method suited to a communication partner.

The present invention also makes it possible to acquire necessary information by tracing a hierarchy.

Other effects of the present invention will become apparent from the following explanation of embodiments.

### BRIEF DESCRIPTION OF DRAWINGS

FIG. 1 is a view showing the basic configuration of a whole profile management system;

FIG. 2 is a system block diagram when an apparatus controller (communication device) connecting to a profile management system according to an embodiment of the present invention is implemented by using a PC (Personal Computer);

FIG. 3 is a view showing the structure of profile information used in the profile management system according to the embodiment of the present invention;

FIG. 4 is a view showing the configuration of a profile management system according to the first embodiment of the present invention;

FIG. 5 is a view showing the module configuration of an apparatus controller (communication device) connecting to the profile management system according to the first embodiment;

FIG. 6 is a flowchart showing the procedure of a metaprofile exchanging process executed between apparatus controllers (communication devices) connecting to the profile management system according to the first embodiment of the present invention; and

FIG. 7 is a flowchart showing the procedure of a profile exchanging process executed between apparatus controllers (communication devices) connecting to the profile management system according to the first embodiment of the present invention.

### BEST MODE FOR CARRYING OUT THE INVENTION

Embodiments according to the present invention will be explained below with reference to the accompanying drawings. Although practical processing examples will also be described, the present invention is not limited to these practical processing examples.

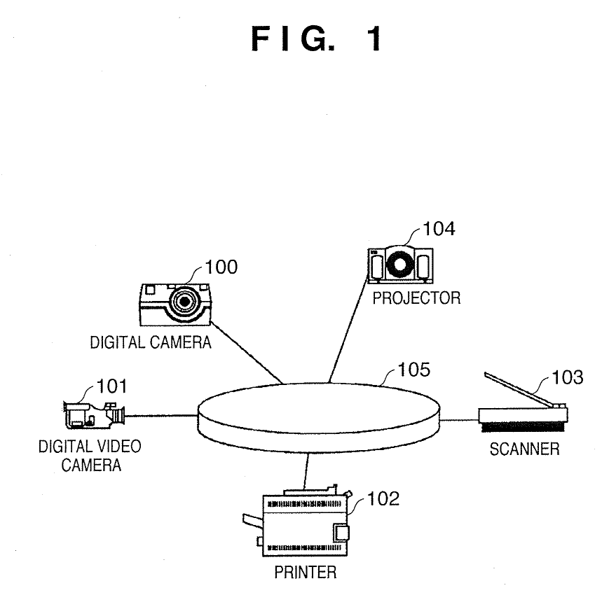

FIG. 1 is a view showing the overall configuration of a system according to an embodiment of the present invention. As shown in FIG. 1, a digital camera 100, digital video camera 101, printer 102, scanner 103, and projector 104 are connected to a network 105. Although this embodiment takes these devices (apparatuses or communication devices) as examples, the present invention is not limited to them.

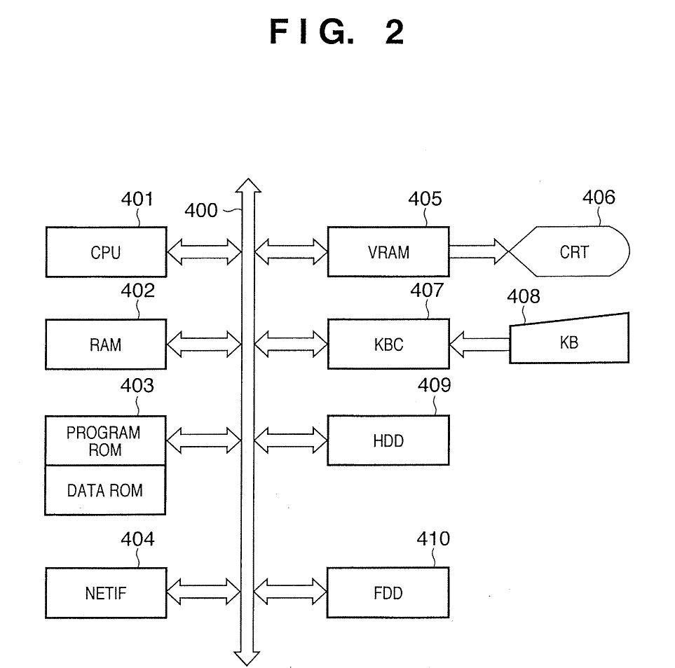

A block diagram when an apparatus controller (communication device) (the devices (apparatuses) 100 to 104 shown in FIG. 1) connecting to a profile management system of the embodiment of the present invention is constituted by a computer system such as a PC (Personal Computer) will be explained below with reference to FIG. 2. Note that the configuration of an apparatus to be controlled is the same as FIG. 2.

Note also that the apparatus controller can be implemented not only by a PC (Personal Computer) but also by the devices as shown in FIG. 1, terminals having a communication function of communicating with other apparatus controllers, which include, for example, a workstation, a notebook PC, a palmtop PC, various household appliances such as a television set having a built-in computer, a game machine having a communication function, a telephone, a facsimile apparatus, a cell phone, a PHS, and an electronic pocketbook, or combinations of these devices and terminals.

Reference numeral 401 in FIG. 2 denotes a central processing unit (to be referred to as a CPU hereinafter) that controls the computer system. The CPU 402 is a computer that operates in accordance with programs, and performs determination and control to be described later. Reference numeral 402 denotes a random access memory (to be referred to as a RAM hereinafter) that functions as a main memory of the CPU 401, an area of execution programs, an execution area of the programs, and a data area.

Reference numeral 403 denotes a read-only memory (to be referred to as a ROM hereinafter) recording the operation procedures of the CPU 401. The ROM 403 includes a program ROM recording basic software (OS) as a system program for performing apparatus control of the computer system, and a data ROM recording, for example, information necessary to operate the system. An HDD 409 to be described later is sometimes used instead of the ROM 403.

Reference numeral 404 denotes a network interface (to be referred to as an NETIF hereinafter) that performs control for transferring data between computer systems across the network 105 and diagnoses the connection status. Each device shown in FIG. 1 communicates with other devices via the NERIF 404.

Reference numeral 405 denotes a video RAM (to be referred to as a VRAM hereinafter) that renders images to be displayed on the screen of a CRT 406 to be described later that displays the operation state of the computer system, and controls the display of the CRT 406. Reference numeral 406 denotes a display device such as a display. The display 406 will be referred to as a CRT hereinafter.

Reference numeral 407 denotes a controller that controls input signals from an external input device 408 to be described below. Reference numeral 408 denotes the external input device such as a keyboard for accepting operations the user of the computer system performs on it.

Reference numeral 409 denotes a storage device such as a hard disk. The HDD 409 is used to save application programs and data such as image information. In this embodiment, the application programs are software programs that execute various apparatus control means constituting this embodiment. Reference numeral 410 denotes an external input/output device that inputs and outputs a removable (registered trademark) such as a floppy (registered trademark) disk drive or CD-ROM drive, and is used to read out the application programs described above from the medium. The external input/output device 401 will be referred to as an FDD hereinafter. Note that the application programs and data stored in the HDD 409 may also be used by storing them in the FDD 410.

Reference numeral 400 denotes an input/output bus (an address bus, data bus, and control bus) for connecting the units described above.

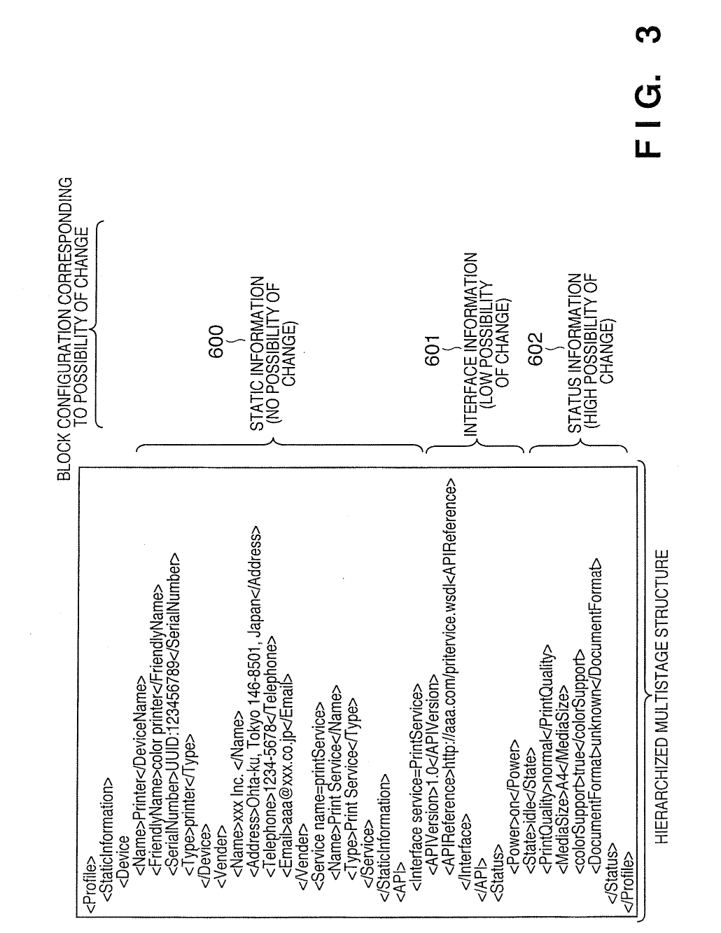

FIG. 3 shows an example of profile information (predefined specifications and settings) of the printer 102 according to the embodiment of the present invention.

As shown in FIG. 3, individual elements constituting the profile information have a hierarchized multistage structure from which only necessary information can be obtained by tracing the hierarchy. In addition, this structure has three blocks different in possibility of change, that is, static information 600 having no possibility of change, interface information 601 having a low possibility of change, and status information having a high possibility of change, and a processing method can be changed from one block to another. The static information 600 is, for example, the name and manufacturer of a device, and the name of a service provided by the device. The interface information 601 is, for example, an API as an interface for calling the service, and the status information is, for example, ON/OFF of the power supply and the operation state (“in operation” or “standby”).

Note that the profile information includes the three blocks in accordance with the possibility of change in FIG. 3, but the number of blocks is not limited to 3. Note also that the block dividing method is not limited to the method corresponding to the possibility of change.

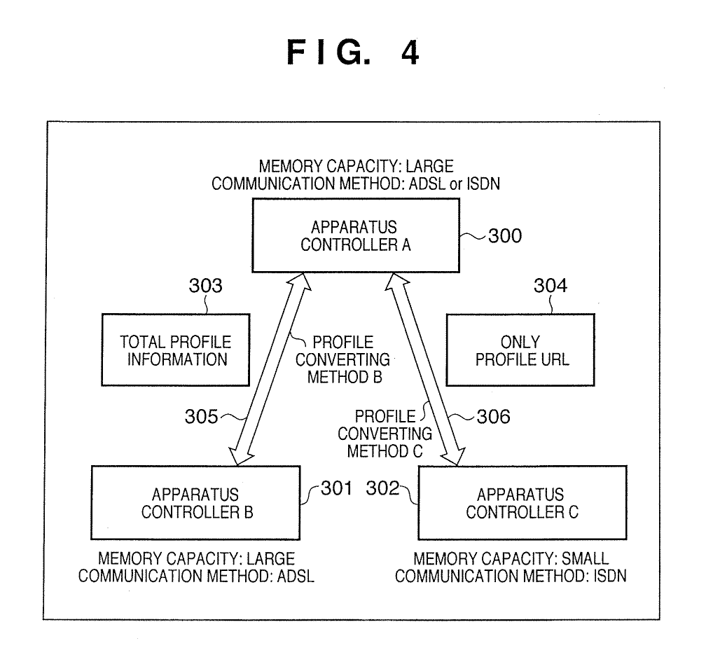

In an embodiment shown in FIG. 4, when exchanging profiles with an apparatus controller (communication device) B 301, an apparatus controller (communication device) A 300 exchanges total profile information 303 by using a profile exchanging method B 305. When exchanging profiles with an apparatus controller C 302, the apparatus controller A 300 exchanges only a URL 304 having an open profile by using a profile exchanging method C 306. The apparatus controllers (communication devices) A 300, B 301, and C 302 are devices (apparatuses) such as the digital camera 100, digital video camera 101, printer 102, scanner 103, and projector 104, as shown in FIG. 1.

As described above, the profile exchanging method to be used can be changed in accordance with an apparatus controller as an object of profile information exchange.

That is, in this embodiment shown in FIG. 4, when exchanging profiles with the apparatus controller (communication device) B 301 having large amounts of hardware resources and a well-secured communication band (e.g., a large memory capacity and ADSL communication capability), the apparatus controller (communication device) A 300 exchanges the total profile information 303 by using the profile exchanging method B 305. On the other hand, when exchanging profiles with the apparatus controller (communication device) C 302 having strictly limited hardware and a narrow communication band (e.g., a small memory capacity and ISDN communication capability), the apparatus controller (communication device) A 300 exchanges only the URL 304 having an open profile by using the profile exchanging method C 306. In this case, the amount of transmission data on a narrow-band ISDN line can be reduced by exchanging not the total profile information but only the URL having an open profile. Also, the amount of data that needs to be held in the memory is small because the data is only the URL; only necessary information of actual data of the profile can be acquired only when necessary by using the URL, so the load on the memory capacity can also be reduced.

As described above, this embodiment can select and perform an optimum profile exchanging method in accordance with the communication band (the network quality between the apparatus controllers A 300 and B 301 or between the apparatus controllers A 300 and C 302), and the conditions such as the CPU speed and the memory capacity (the capability of a connection partner) of an apparatus controller as an object of profile information exchange.

The apparatus controller A 100 receives, from a communication partner (the apparatus controller B 301 or C 302), the communication band as information of a network to which the communication partner is connected, and the CPU speed and memory capacity as information representing the capability of the connection partner, before receiving a profile of the communication partner.

Note that this embodiment takes the communication band, memory capacity, and the like as examples of the conditions of an apparatus controller, but the conditions are not limited.

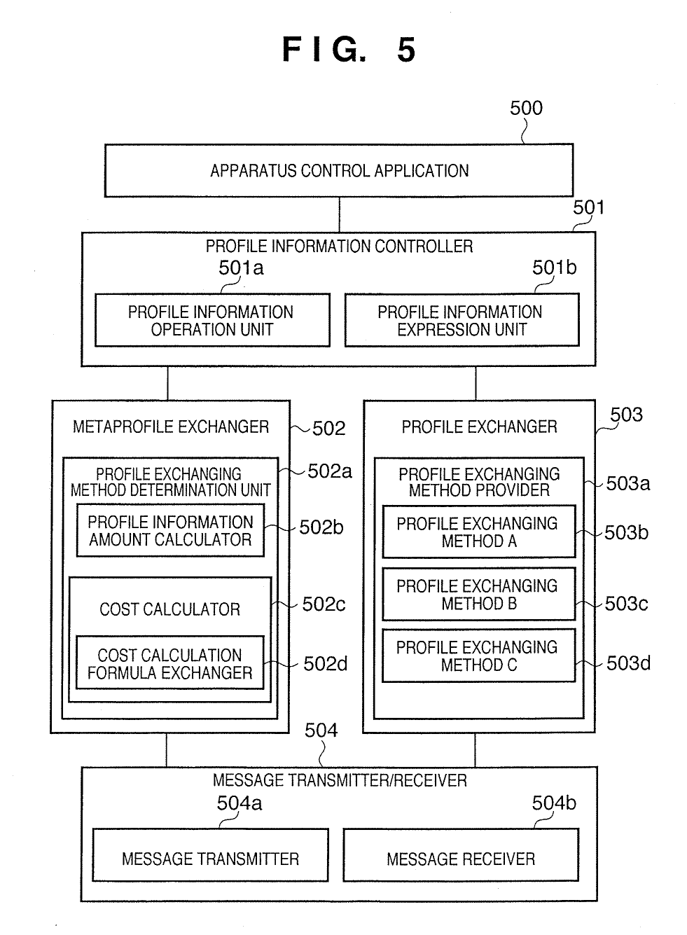

Application modules executed by the apparatus controller (communication device) (300, 301, or 302 in FIG. 4) connected to the profile management system according to the embodiment of the present invention will be explained below with reference to FIG. 5. Note that the application modules described below are achieved by supplying a recording medium recording program codes of software that implements the functions to a system or apparatus, and reading out and executing the program codes stored in the storage medium by a computer (a CPU (401 in FIG. 2) or MPU) of the system or apparatus.

In this case, the program codes themselves read out from the storage medium implement the functions of the above-mentioned embodiment, and the storage medium (403, 409, or 410 in FIG. 2) recording the program codes constitutes the present invention.

In addition to implementing the functions of the above embodiment by executing the readout program codes by the computer, the present invention also includes the case that an OS (Operating System) or the like running on the computer performs part or the whole of actual processing based on instructions of the program codes, thereby implementing the functions of the above embodiment.

Furthermore, the present invention includes the case that the program codes read out from the storage medium are written in a memory of a function expansion board inserted into the computer or of a function expansion unit connected to the computer, and a CPU or the like of the function expansion board of function expansion unit performs part or the whole of actual processing based on instructions of the program codes, thereby implementing the functions of the above embodiment.

The explanation will return to FIG. 5. The apparatus controller connected to the profile management system has an apparatus control application 500, profile information controller 501, metaprofile exchanger 502, profile exchanger 503, and message transmitter/receiver 504.

The profile information controller 501 includes a profile information operation unit 501a and profile information expression unit 501b. FIG. 3 shows an example of the profile information of the printer 102 formed by the profile information expression unit 501b.

The metaprofile exchanger 502 includes a profile exchanging method determination unit 502a. The profile exchanging method determination unit 502a includes a profile information amount calculator 502b and cost calculator 502c. The cost calculator 502c includes a cost calculation formula exchanger 502d.

The profile exchanger 503 includes a profile exchanging method provider 503a. The profile exchanging method provider 503a includes profile exchanging methods A 503b, B 503c, and C 603d. Note that although the profile exchanging method provider 503a holds the three profile exchanging methods in FIG. 4, the number of profile exchanging methods is not limited to 3 but corresponds to the number of profile exchanging methods that can be handled.

The message transmitter/receiver 504 includes a message transmitter 504a and message receiver 504b.

That is, this embodiment is directed to the profile management system including a plurality of apparatus controllers (e.g., the digital camera 100) that can be controlled across a network. The profile management system of this embodiment has the following components:
The profile information expression unit 501b
The profile information operation unit 501a capable of acquiring or operating the specifications and settings of an apparatus controller expressed by the profile information expression unit 501b
The metaprofile exchanger 502 that exchanges preliminary information with an apparatus controller (e.g., the printer 102) as an object of profile information exchange before exchanging profiles
The profile exchanger 503 capable of selectively using a plurality of exchanging methods.

Note that the profile information expression unit 501b described above expresses the predefined specifications and settings of an apparatus controller to be controlled by combining the blocked structure and hierarchized multistage structure of, for example, the following information:
In accordance with the possibility of change of an apparatus controller (e.g., the digital camera 100) constituting the profile management system, static information having no possibility of change
Interface information such as an API having low possibility of change
Information such as a status having high possibility of change.

This embodiment makes it possible, by expressing the profile information by the hierarchized multistage structure, to exchange only necessary information by tracing the hierarchy, and exchange preliminary information before profile exchange.

The metaprofile exchanger 502 has the profile exchanging method determination unit 502a that determines a method of exchanging, with an apparatus controller as an object of profile information exchange, the profile information such as the specifications and settings of the apparatus controller. Accordingly, it is possible to select a profile exchanging method most suited to the network status and the conditions such as the memory capacity and CPU speed of an apparatus controller constituting the profile management system.

The profile exchanging method determination unit 502a has the profile information calculator 502b and cost calculator 502c. The cost calculator 502c calculates the total cost required for profile exchange based on various kinds of cost information necessary for profile exchange. This makes it possible to calculate the total cost from various kinds of cost information necessary for profile exchange, for example, the amount of information of a profile, the network status (quality), and the memory capacity and CPU speed (the capability of a connection partner). It is also possible to select a profile exchanging method most suited to the conditions of an apparatus controller based on the total cost. Note that the metaprofile exchanger 502 receives, from a connection partner, the amount of information of a profile, information of a network to which the communication partner is connected, and the capability of the connection partner.

The profile information calculator 502b calculates the amount of profile information by weighting the amount of information of each block of the profile information expressed by the blocked structure. Therefore, it is possible to calculate the amount of profile information by taking account of the possibility of change, for example, static information having no possibility of change, interface information such as an API having a low possibility of change, and information such as a status having a high possibility of change.

The cost calculator 502c calculates the total cost by using predetermined parameters and a default cost calculation formula. In this embodiment, the predetermined parameters are the profile information amount calculated by the profile information amount calculator 502b, and various cost values, for example, the network cost (network quality) such as the communication band. Accordingly, the total cost can be calculated by the default cost calculation formula by using the amount of profile information obtained by the profile information amount calculator 502b by taking the possibility of change into account, and the various kinds of cost information.

The cost calculator 502c has the cost calculation formula exchanger 502d that exchanges cost calculation formulas to be used with an apparatus controller as an object of file information exchange, if the cost calculator 502c cannot calculate the total cost by using the default cost calculation formula. Even when the default cost calculation formula is incapable of calculating the total cost, therefore, an appropriate total cost can be calculated by exchanging cost calculation formulas to be used with an apparatus controller as an object of profile exchange.

The profile exchanger 503 has the profile exchanging method provider 503a that has the plurality of prepared profile exchanging methods 503a, 503b, and 503c, and provides a profile exchanging method determined by the profile exchanging method determination unit 502a. This makes it possible to provide an optimum profile exchanging method determined by the profile exchanging method determination unit 503a.

An example of the profile information amount calculation formula (700) used by the profile information amount calculator 502b in the apparatus controller (communication device) connected to the profile management system according to the embodiment of the present invention is
PS=3*SS+5*IS+10*DS 700

A profile information amount PS is calculated by the formula 700 by using SS as the number of bytes of the information (static information) 600 having no possibility of change, IS as the number of bytes of the information (interface information) 601 having a low possibility of change, and DS as the number of bytes of information (status information) 602 having a high possibility of change shown in FIG. 3. The profile information calculator 502b calculates the amount of profile information by weighting, as indicated by the formula 700, the amount of information of each block of the profile information expressed by the blocked structure.

In this embodiment, the weight of the static information 600 is light, and that of the status information is heavy, compared to the interface information 601. Note that the weights of the individual variables used in the formula 700 are 3, 5, and 10, but the weights are not limited to these values and can be properly changed in accordance with the situation.

Also, the numbers of bytes of the three blocks forming the profile information shown in FIG. 3 are used as variables because FIG. 3 is configured by the three blocks. If the number of blocks forming the profile information is changed, the number of variables used in the formula 700 is also changed.

An example of the default total cost calculation formula (800) used by the cost calculator 502c in the apparatus controller (communication device) connected to the profile management system according to the embodiment of the present invention is
TC=PS*NC+PS*MC 800

A total cost TC is calculated by the formula 800 by using the amount of profile information PS calculated by the formula 700, a network cost NC, and a memory cost MC. The amount of profile information PS, the network cost NC (e.g., the type and transmission rate of a network to which a communication partner is connected), and the memory cost MC (memory capacity) are received from the communication partner. The cost calculator 502c calculates the total cost by using predetermined parameters and the default cost calculation formula 800. Examples of the predetermined parameters are an amount of profile information 802 calculated by the profile information amount calculator 502b, and various cost values, for example, a network cost (network quality) 803 such as the communication band. If the formula 800 cannot be used to calculate the total cost, the cost calculation formula exchanger 502d can achieve a proper cost calculation by exchanging cost calculation formulas with an apparatus controller as an object of profile information exchange.

Note that although the formula 800 uses the two pieces of cost information, that is, the network cost 803 such as the communication band and a memory cost 804, the number of cost information is not limited to 2 but corresponds to the number of cost information that can be handled.

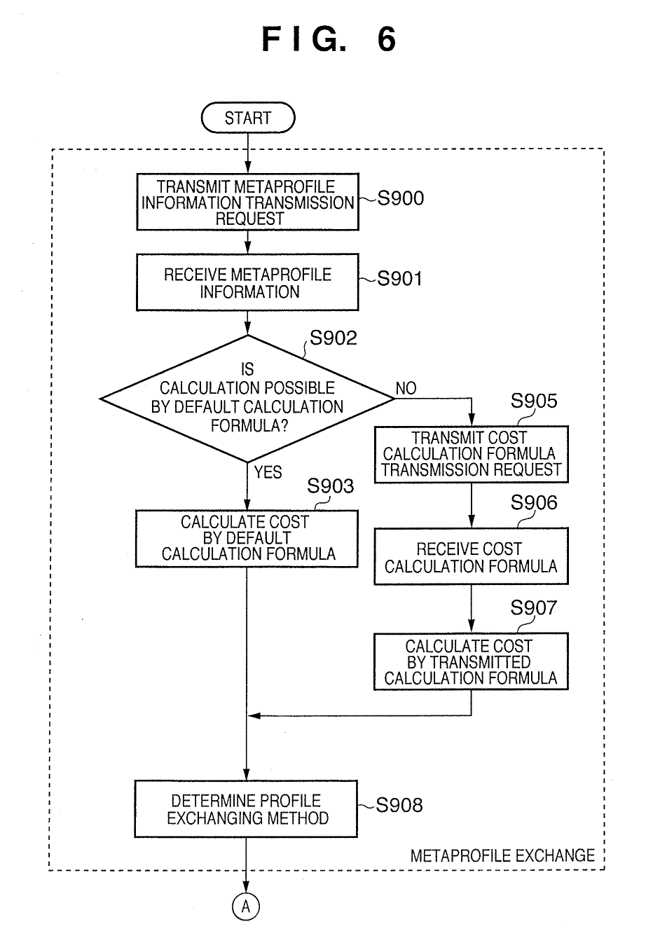

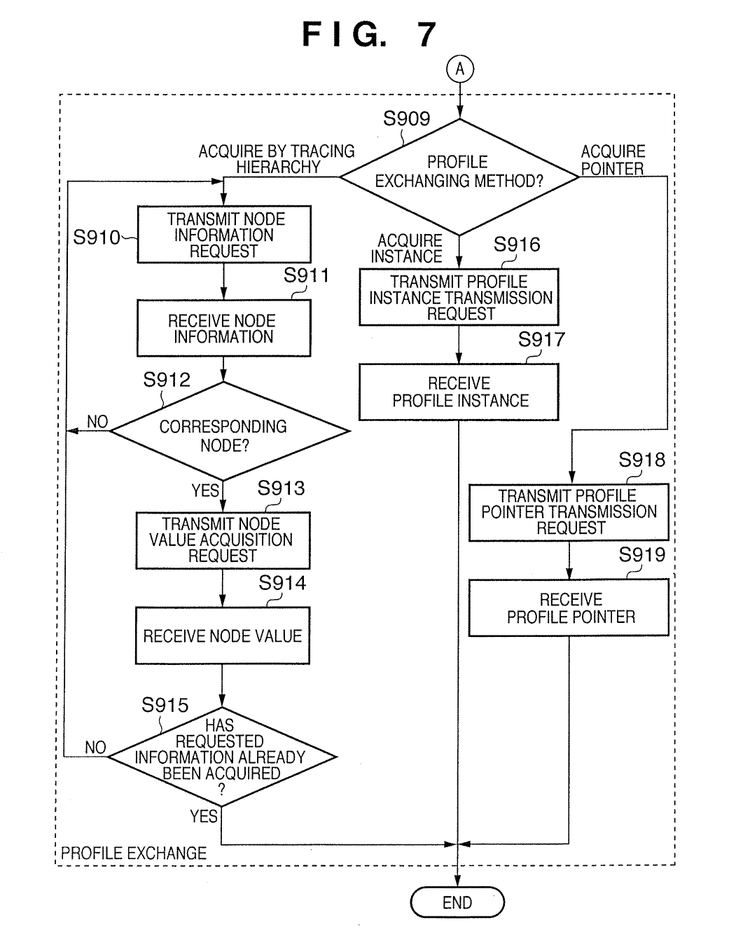

FIGS. 6 and 7 are flowcharts showing a profile exchanging process performed by the apparatus controller (communication device) connected to the profile management system according to the embodiment of the present invention. These flowcharts shown in FIGS. 6 and 7 indicate parts of a program executed by the CPU 401 as a computer. This program is stored in the program ROM 403 so that the CPU 401 can read it out. The program may also be read out from the HDD 409 or FDD 410. FIG. 6 is a flowchart of metaprofile exchange, and FIG. 7 is a flowchart of profile exchange. Note that FIG. 7 shows the case that the device has three profile exchanging methods, that is, a method of acquiring necessary information by tracing the hierarchical structure of the profile information, a method of acquiring the whole profile information (instance), and a method of acquiring a profile pointer (open URL).

First, in step S900, the metaprofile exchanger 502 causes the message transmitter 504a to transmit a metaprofile information transmission request to an apparatus controller as an object of profile information exchange.

Then, in step S901, the message receiver 504b receives metaprofile information from the apparatus controller as an object of profile information exchange. The metaprofile information (preliminary information) indicates whether the default calculation formula is capable of calculation, and also indicates variable information and variable values for use in the formula, and the like. Examples of the variable values are the amount of information SS of the static information 600, the amount of information IS of the interface information 601, and the amount of information DS of the status information 602. Examples of the variable values are the network status (quality), the memory capacity, and the CPU speed (the capability of the connection partner).

In step S902, whether the calculation is possible by the default cost calculation formula 800 is determined.

If it is determined in step S902 that the calculation is possible by the default cost calculation formula 800, the cost calculator 502c calculates the total cost by using the default cost calculation formula 800 in step S903.

As described above, in step S903, this embodiment calculates the amount of profile information, and calculates the total cost necessary for profile exchange based on the various kinds of cost information required for profile exchange. Accordingly, the total cost can be calculated from the amount of profile information and the various kinds of cost information necessary for profile exchange, for example, the network status (quality), the memory capacity, and the CPU speed (the capability of the connection partner). It is also possible to select a profile exchanging method most suited to the conditions of the apparatus controller based on the total cost.

In step S903, the amount of profile information is calculated by weighting, by using the formula 700, the amount of information of each block of the profile information expressed by the blocked structure. That is, the amount of profile information is calculated by taking account of the possibility of change in the profile information, that is, the static information having no possibility of change, the interface information such as an API having a low possibility of change, and information such as the status having a high possibility of change.

In step S903, the total cost is calculated by using the calculated amount of profile information, the various cost values, for example, the network cost such as the communication band, and the default cost calculation formula. That is, the total cost is calculated by the default cost calculation formula by using the amount of profile information calculated by taking the possibility of change into account, and the various kinds of cost information.

The process has cost calculation formula exchanging steps S905 and S906 of exchanging cost calculation formulas with the apparatus controller as an object of profile information exchange, if the total cost cannot be calculated by using the default cost calculation formula (step S902). Even when the default cost calculation formula cannot be used to calculate the total cost, therefore, a proper total cost can be calculated by exchanging cost calculation formulas to be used with the apparatus controller as an object of profile exchange.

If it is determined in step S902 that the calculation is impossible by the default cost calculation formula 800, the process advances to step S905. The cost calculation formula exchanger 502d causes the message transmitter 504a to transmit a cost calculation formula transmission request to the apparatus controller as an object of profile information exchange.

In step S906, the message receiver 504b receives a cost calculation formula from the apparatus controller as an object of profile information exchange. That is, if the total cost cannot be calculated by using the default cost calculation formula 800, the cost calculation formula exchanger 502b exchanges cost calculation formulas to be used with the apparatus controller as an object of profile information exchange.

In step S907, the total cost is calculated by using the received cost calculation formula.

In step S908, based on the total cost value calculated in step S903 or S907 and a total cost threshold table held in the profile exchanging method determination unit 502a, the profile exchanging method determination unit 502a determines, as a profile exchanging method, one of the following methods: a method of acquiring necessary information by tracing the hierarchical structure of the profile information, a method of acquiring the whole profile information (instance), and a method of acquiring a file pointer (open URL).

The total cost threshold table is set, for example, as follows. That is, if the total cost TC is less than twice the profile information amount PS, the whole profile information (instance) is acquired. If the TC is more than twice and less than five times the PS, necessary information is acquired by tracing the hierarchical structure of the profile information. If the TC is five times or more the PS, a profile pointer (open URL) is acquired. Note that the lower and upper limits of the total cost of each profile exchanging method to be used are thus set in this embodiment, but the lower and upper limits are not limited to these values.

Profile exchanging method determination step S908 determines a method of exchanging, with the apparatus controller (printer 102) as an object of profile information exchange, the profile information such as the specifications and settings of the apparatus controller. This makes it possible to select a profile exchanging method most suited to the network status and the conditions such as the memory capacity and the CPU speed (the capability of the connection partner) of the apparatus controller constituting the profile management system. The process also has a profile exchanging method providing step of preparing a plurality of profile exchanging methods beforehand, and providing the profile exchanging method determined in the profile exchanging method determination step S908. This makes it possible to provide the optimum profile exchanging method determined in the profile exchanging method determination step S908.

This embodiment selects the amount of profile information to be acquired at once, in accordance with the cost for profile information acquisition. That is, this embodiment selects whether to acquire the whole profile at once or acquire the profile of each block.

If it is determined in step S908 to use the method of acquiring necessary information by tracing the hierarchical structure of the profile information, the process advances to step S910. The profile exchanger 503 causes the message transmitter 504a to transmit a node information transmission request to the apparatus controller as an object of profile information exchange.

In step S911, the message receiver 504b receives node information from the apparatus controller as an object of profile information exchange. Root node information of the profile information is received in the first node information reception, so necessary information is acquired by tracing nodes from the root node after that. When the profile information is the one shown in FIG. 3, information of the element <Profile>as the root node is acquired. More specifically, the contents that the element <Profile> has <StaticInformation>, <API>, and <Status> as child elements are acquired.

In step S912, whether the received node information is necessary node information is determined.

If it is determined in step S912 that the received node information is not the necessary node information, the profile exchanger 503 causes the message transmitter 504a to retransmit the node information transmission request to the apparatus controller as an object of profile information exchange in step S910.

If it is determined in step S912 that the received node information is the necessary node information, the profile exchanger 503 causes the message transmitter 504a to transmit a node value acquisition request in step S913.

In step S914, the message receiver 504b receives a node value from the apparatus controller as an object of profile information exchange.

In step S915, whether all pieces of necessary information are obtained is determined.

If it is determined in step S915 that not all pieces of necessary information are obtained, the profile exchanger 503 causes the message transmitter 504a to retransmit the node information transmission request to the apparatus controller as an object of profile information exchange in step S910.

If it is determined in step S915 that all pieces of necessary information are obtained, the process is terminated.

If it is determined in step S908 to use the method of acquiring the whole profile information (instance), the process advances to step S916. The profile exchanger 503 causes the message transmitter 504a to transmit a profile instance transmission request to the apparatus controller as an object of profile information exchange.

In step S917, the message receiver 504b receives a profile instance, and the process is terminated.

If it is determined in step S908 to use the method of acquiring a profile pointer (open URL), the profile exchanger 503 causes the message transmitter 504a to transmit a profile pointer transmission request in step S918.

In step S919, the message receiver 504b acquires a profile pointer (the URL of the whole profile, and the URLs of the individual blocks (the static information block, interface information block, and status information block)) from the apparatus controller as an object of profile information exchange, and the process is terminated. After that, the profile information is obtained where necessary by using this profile pointer. That is, the profile information is obtained by designating the whole profile or each block by using the URL.

If it is determined in step S908 to use the method of acquiring necessary information by tracing the hierarchical structure of the profile information, for example, if the digital camera 100 intends to acquire the device name of the printer 102 (in the case shown in FIG. 3, the device name is the content “printer” of the element <Name> as a child element of the element <Device>), the procedure is as follows.

1. In step S910, the digital camera 100 transmits a node information request to the printer 102.

2. In step S911, information of the element <Profile> as the root node is acquired. Practical contents are that the element <Profile> has the tag elements <StaticInformation>, <API>, and <Status> as child elements.

3. In step S912, the process branches to N because no information of the corresponding node is obtained.

4. In step S910, a node information request is transmitted to acquire information of the element <StaticInformation>.

5. In step S911, information of the element <StaticInformation> is acquired. Practical contents are that the element <StaticInformation> has the tag elements <Device>, <Vender>, and <Service> as child elements.

6. In step S910, a node information request is transmitted to acquire information of the element <Device>.

7. In step S911, information of the element <Device> is acquired. Practical contents are that the element <Device> has the tag elements <Name>, <FriendlyName>, <SerialNumber>, and <Type> as child elements.

8. In step S910, a node information request is transmitted to acquire information of the element <Name>.

9. In step S911, information of the element <Name> is acquired. More specifically, information indicating that the element has a text element is obtained.

10. In step S912, the process branches to Y because information of the corresponding node is obtained.

11. In step S913, a node value acquisition request is transmitted to acquire the value of the element <Name>.

12. In step S914, “printer” as the node value is acquired.

Note that if the digital camera 100 already has a cache of the profile information of the printer 102, it is possible to trace nodes not from the root node but from any arbitrary node. That is, it is possible to transmit a node information-request for acquiring information of the element <Name> without starting from the acquisition of information of the element <Profile> as the root node.

In this embodiment as described above, the digital camera 100 acquires necessary information by tracing the hierarchy of hierarchized profile structure of a communication device (e.g., the printer 102) connected across the network 105.

The digital camera 100 also acquires element information of a predetermined layer (e.g., the root node) from the hierarchized profile information of the connection partner (printer 102) (steps S910 and S911). The digital camera 100 then selects en element to be obtained next (e.g., information of the element <StaticInformation>) from the acquired element information, and obtains element information of the selected element (steps S910 and S911).

This embodiment includes a profile information expressing step of expressing the profile of an object device (e.g., the printer 102) obtained as described above. This profile information expressing step expresses the profile of the object device by combining the blocked structure and hierarchized multistage structure. The profile information expression unit 501b implements the profile information expressing step.

This embodiment also has the following steps:
The profile information acquiring step (step S914 or S917) of acquiring the profile of an object device expressed in the profile information expressing step
The preliminary information receiving step (step S900) of receiving preliminary information (a metaprofile) from the object device before acquisition of the profile
The profile acquiring method selecting step (step S908) of selecting a method of acquiring the profile in accordance with the received preliminary information.

This embodiment determines a method of acquiring the profile of a communication partner (e.g., the printer 102) in accordance with the information amount of the profile of the connection partner (step S908), and acquires the profile from the communication partner by the determined method (step S914 or S917).

This embodiment is directed to a profile management method executed by an apparatus controller (e.g., the digital camera 100) connected to the profile management system constituted by a plurality of apparatus controllers (the digital camera 100 and the like) controllable across a network. As described above, each apparatus controller constituting the profile management system has the profile information expressing step of expressing the predefined specifications and settings of an apparatus controller to be controlled.

This profile information expressing step expresses the predefined specifications and settings of an apparatus controller to be controlled, by combining the blocked structure and hierarchized multistage structure such as the following information:
In accordance with the possibility of change, static information having no possibility of change
Interface information such as an API having a low possibility of change, a status having a high possibility of change, and the like.

This embodiment further has the following steps:
A profile information operating step capable of obtaining or operating the specifications and settings of an apparatus controller expressed in the profile information expressing step
A metaprofile exchanging step of exchanging preliminary information before profile exchange with an apparatus controller as an object of profile information exchange, in the profile information operating step
A profile exchanging step capable of selectively using a plurality of exchanging methods.

Accordingly, it is possible by expressing the profile information by the hierarchized multistage structure to exchange only necessary information by tracing the hierarchy, and exchange preliminary information before profile exchange.

Note that when transmitting and receiving data, the message transmitter 504a and message receiver 504b use SOAP as a communication protocol. HTTP is used as the low-order protocol of SOAP, and Internet Protocol (IP) is used as the low-order protocol of HTTP. In this case, both versions IPv4 and IPv6 can be used as IP. Also, a medium actually used as a communication path can be either a wired path or wireless path. Since SOAP is independent of any low-order protocol, communication protocols such as TCP, UDP, HTTP, SMTP, SNMP, and FTP are sometimes used.

As has been explained above, the embodiment of the present invention can provide a profile management system capable of exchanging only necessary information by tracing a hierarchy by expressing profile information by a hierarchized multistage structure. The embodiment introduces a metaprofile exchanging means, and uses in this metaprofile exchanging means a profile exchanging method determining means for determining a profile exchanging method based on the amount of information of a profile and various kinds of cost information required for profile exchange. Therefore, it is possible to provide a profile management system capable of selecting a profile exchanging method most suited to the network status and the conditions such as the memory capacity and CPU speed of an apparatus controller constituting the profile management system.

Although the present invention has been explained based on the preferred embodiment, the present invention is not limited to the above embodiment and can be variously modified within the scope of claims.

Declaration of Priority

This application claims the benefit of Japanese Patent Application No. 2004-325095, filed Nov. 9, 2004, which is hereby incorporated by reference herein in its entirety.

1. A profile acquiring method comprising:
determining a method of acquiring a profile of a communication partner in accordance with information received from the communication partner; and
acquiring the profile from the communication partner by the determined method.

2. A profile acquiring method according to claim 1, wherein the information received from the communication partner represents an amount of information of the profile of the communication partner.

3. A profile acquiring method according to claim 1, wherein the information received from the communication partner represents a network to which the communication partner is connected.

4. A profile acquiring method according to claim 1, wherein the information received from the communication partner represents capability of the communication partner.

5. A profile acquiring method according to claim 1, wherein in the determining step, the profile of the communication partner is divisionally acquired.

6. A profile acquiring method according to claim 1, wherein in the determining step, desired information is acquired from hierarchized profile information of the communication partner by tracing the hierarchy.

7. A profile acquiring method according to claim 1, wherein in the acquiring step, element information of a predetermined layer is acquired from hierarchized profile information of a connection partner, an element to be acquired next is selected from the acquired element information, and element information of the selected element is acquired, in accordance with the determined method.

8. A profile acquiring apparatus comprising:
a determination unit adapted to determine a method of acquiring a profile of a communication partner in accordance with information received from the communication partner; and
an acquisition unit adapted to acquire the profile from the communication partner by the method determined by the determination unit.

9. A profile acquiring apparatus according to claim 8, wherein the information received from the communication partner represents an amount of information of the profile of the communication partner.

10. A profile acquiring apparatus according to claim 8, wherein the information received from the communication partner represents a network to which the communication partner is connected.

11. A profile acquiring apparatus according to claim 8, wherein the information received from the communication partner represents capability of the communication partner.

12. A profile acquiring apparatus according to claim 8, wherein said determination unit determines to divisionally acquire the profile of the communication partner.

13. A profile acquiring apparatus according to claim 8, wherein said determination unit acquires desired information from hierarchized profile information of the communication partner by tracing the hierarchy.

14. A profile acquiring apparatus according to claim 8, wherein said acquisition unit acquires element information of a predetermined layer from hierarchized profile information of a connection partner, selects an element to be acquired next from the acquired element information, and acquires element information of the selected element, in accordance with the determined method.

15. A profile acquiring program stored on a computer-readable storage medium for causing a computer to executing a profile acquiring method, the method comprising:
determining a method of acquiring a profile of a communication partner in accordance with information received from the communication partner; and
acquiring the profile from the communication partner by the determined method.

16. A profile acquiring program according to claim 15, wherein the information received from the communication partner represents an amount of information of the profile of the communication partner.

17. A profile acquiring program according to claim 15, wherein the information received from the communication partner represents a network to which the communication partner is connected.

18. A profile acquiring program according to claim 15, wherein the information received from the communication partner represents capability of the communication partner.

19. A profile acquiring program according to claim 15, wherein in the determining step, it is determined to divisionally acquire the profile of the communication partner.

20. A profile acquiring program according to claim 15, wherein in the determining step, desired information is acquired from hierarchized profile information of the communication partner by tracing the hierarchy.

21. A profile acquiring program according to claim 15, wherein in the acquiring step, element information of a predetermined layer is acquired from hierarchized profile information of a connection partner, an element to be acquired next is selected from the acquired element information, and element information of the selected element is acquired, in accordance with the determined method.

22. A computer-readable storage medium storing a profile acquiring program for causing a computer to executing a profile acquiring method, the method comprising:
determining a method of acquiring a profile of a communication partner in accordance with information received from the communication partner; and
acquiring the profile from the communication partner by the determined method.
